(19) United States
(12) Patent Application Publication
(10) Pub. No.: US 2004/0207557 A1
(43) Pub. Date: Oct. 21, 2004

(54) PERPENDICULARLY-ORIENTED INVERTED F ANTENNA

(76) Inventors: Kuo-Cheng Chen, Tao-Yuan City (TW); Hui-Feng Lee, Tao-Yuan City (TW); Chien-Hua Ma, Tao-Yuan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,643

(22) Filed: Aug. 6, 2003

(30) Foreign Application Priority Data
Apr. 17, 2003 (TW) 092108999

(51) Int. Cl. H01Q 1/24

(52) U.S. Cl. 343/702

(57) ABSTRACT

An antenna connected to a board includes a radiator perpendicular to the circuit board for transmitting and receiving radio frequency signals, a feeding plate stretching out from the radiator and connected to a feed pad on the circuit board for transmitting radio frequency signals, and a ground plate stretching out from the radiator, which is connected to a ground plane on the circuit board.

### BACKGROUND OF INVENTION

1. Field of the Invention

The present invention relates to an antenna for wireless communication, and more specifically, to a perpendicularly-oriented inverted F antenna (POIFA) with a radiator perpendicular to a ground plane.

2. Description of the Prior Art

In modern information-oriented society, it is desirable that information is accessible at anytime and at anyplace. Wireless communication equipment is capable of transmitting signals without the use of cables or optical fibers making wireless communication undoubtedly the best way to transmit information. As technology develops, various kinds of wireless communication devices, such as mobile phones and personal digital assistants (PDAs), have become an important means of communicating due to their compactness and portability.

In the field of wireless communication equipment, antennas, which are used to transmit and receive radio waves in order to transfer and exchange data signals, are unquestionably one of the most important devices. Especially in modern portable wireless communication devices, antennas are required to be compact and must be designed to occupy less space in order to match pace with the miniaturization trend of portable wireless devices. In addition, as the bit rate of radio data signals (sometimes measured in units of bits/second) increases, antenna bandwidth requirements increase as well.

Please refer to FIG. 1. FIG. 1 is a schematic diagram of a planar inverted F antenna (PIFA) 10 positioned on a circuit board 12 according to the prior art. The antenna 10 is a PIFA connected to the circuit board 12, which includes a radiator 14 for receiving and transmitting radio frequency (RF) signals, a feeding plate 16 stretching out from the radiator 14 and connected perpendicularly to a feed pad 18 for transmitting RF signals, and a ground plate 20 stretching out from the radiator 14 and connected perpendicularly to the ground plane 22 on the circuit board 12. The antenna 10 is a single-frequency antenna, which transmits and receives RF signals through the resonance of the radiator 14. The length of the antenna 14 decides the operation frequency for transmitting and receiving of RF signals. The transmission of RF signals between the antenna 10 and the circuit board 12 depends on the connection of the feeding plate 16 of the antenna 10 and the feed pad 18 of the circuit board 12.

However, the antenna 10 according to the prior art is limited in application. For example, because the antenna 10 is positioned on the circuit board 12, the radiator 14 is parallel to the circuit board 12, and furthermore the height of the antenna 10 cannot be shortened to fit the bandwidth requirements; an additional height is required due to the existence of the feeding plate 16 and the ground plate 20, that accordingly influences the size of the antenna 10. Therefore, it is difficult to utilize the antenna 10 according to the prior art when designing compact wireless products.

### SUMMARY OF INVENTION

It is therefore a primary objective of the present invention to provide a POIFA for use with wireless communication.

Briefly summarized, an antenna according to the present invention is connected to a circuit board for use with wireless communication. The antenna includes a radiator for transmitting and receiving RF signals and is perpendicular to a ground plane of the circuit board. A feeding plate stretching out from the radiator is connected to a feed pad of the circuit board for transmitting the RF signals. A ground plate stretching out from the radiator is connected to the ground plane.

### BRIEF DESCRIPTION OF DRAWINGS

FIG. 1 is a diagram of a planar inverted F antenna positioned on a circuit board according to the prior art.

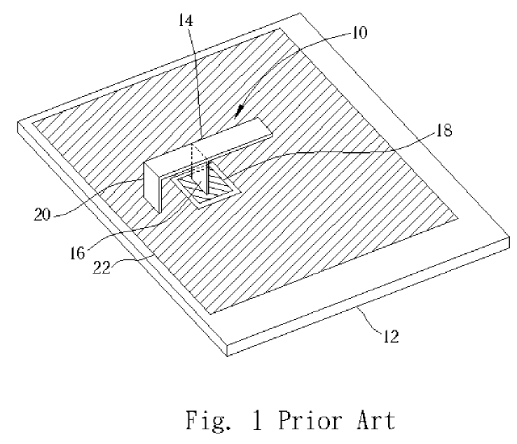

FIG. 2 is a block diagram of an application of the present invention on a PDA.

FIG. 3 is a diagram of the perpendicularly-oriented inverted F antenna according to the first embodiment of the present invention.

FIG. 4 is a diagram of an antenna with a feeding plate connected to the upper edge, and a ground plate connected to the lower edge of the radiator.

FIG. 5 is a schematic diagram of a perpendicularly-oriented inverted F antenna according to the second embodiment to the present invention.

FIG. 6 is a schematic diagram of a perpendicularly-oriented inverted F antenna according to the third embodiment of the present invention.

### DETAILED DESCRIPTION

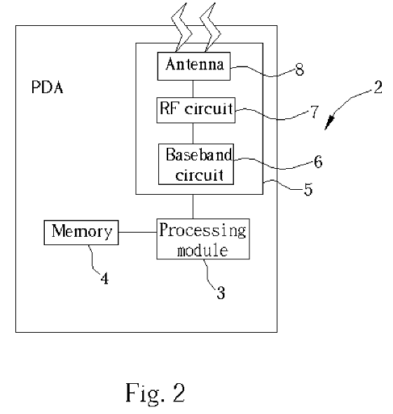

Please refer to FIG. 2. FIG. 2 is a block diagram of an application of the present invention on a PDA 2. The PDA 2 includes a processing module 3 for controlling the operation of the PDA 2, a memory 4 to store data of the PDA 2. The memory 4 can be any kind of storage media, such as CF, SD or MMC flash memories. In order to implement wireless communication, the PDA 2 further includes a wireless communication module 5, which includes a baseband circuit 6, an RF circuit 7, and an antenna 8. The processing module 3 can read out and process the data in the memory 4, then transmit the processed communication signals to the baseband circuit 6. The baseband circuit 6 can encode the communication signals from the processing module 3 into baseband signals, then transmit them to the RF circuit 7. The RF circuit 7 modulates the baseband signals into RF signals and transmits them through the antenna 8. The RF circuit 7 can also receive RF signals through the antenna 8 and demodulate them into baseband signals. The baseband circuit 6 then decodes them into communication signals and transmits them to the processing module 3. The processing module 3 can process the transmitted communication signals and store them into the memory 4.

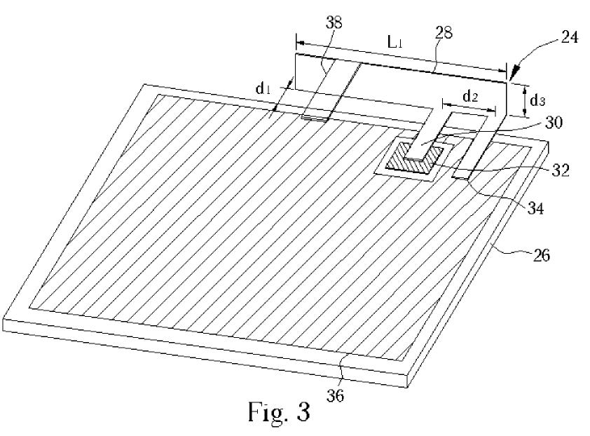

As for the application of the POIFA according to the present invention, please refer to FIG. 3. FIG. 3 is a diagram of the perpendicularly-oriented inverted F antenna 24 according to the first embodiment of the present invention. The antenna 24 is connected to a printed circuit board (PCB) 26. The antenna 24 includes a radiator 28 installed off the PCB 26 for receiving and transmitting RF signals, and a feeding plate 30 stretching out of the radiator 28 and connected to the feed pad 32 on the PCB 26 for transmitting RF signals. The feed pad 32 can receive RF signals from the RF circuit 7 of the wireless communication device and then transfer them to the antenna 24 for transmission, or receive RF signals from the antenna 24 and transfer them to the RF circuit 7 of the wireless communication device for demodulation. The antenna 24 further includes a ground plate 34 stretching out from the radiator 28. The ground plate 34 is connected to a ground plane 36 of the PCB 26. The antenna 24 is a single-frequency antenna, which transmits and receives RF signals through the resonance of the radiator 28. The length of the radiator 28 decides the operation frequency of transmission and reception of RF signals. For example if the antenna 24 is a ¼ wavelength antenna, the length of the radiator 28 is approximately ¼ the wavelength of the transmitted RF signals. The antenna 24 further includes an expanding plate 38 stretching out from a side of the radiator 28 for capacitive loading, which can shorten the necessary length of the radiator 28 for receiving RF signals with a specific frequency. For example, if the expanding plate 38 is attached to the ¼ wavelength antenna, the length of the radiator 28 can be less than ¼ of the wavelength, so that the length of the antenna can be shortened. The transmission of RF signals in the antenna 24 depends on the connection of the feeding plate 30 of the antenna 24 and the feed pad 32 of the PCB 26.

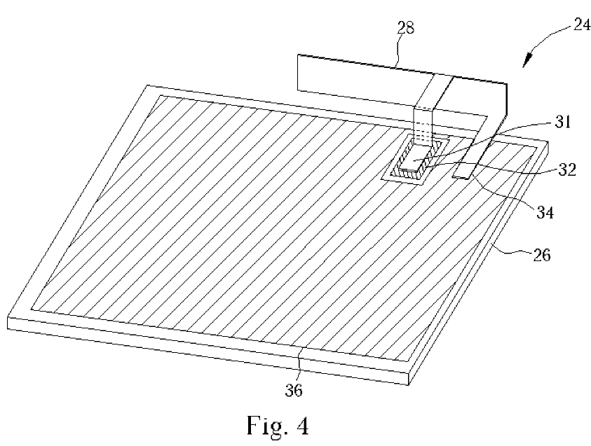

The first embodiment of the present invention can be the application in bluetooth technology or WLAN(802.11b), and the applied frequency band is between 2400-2483.5 MHz. However, this antenna design also can be applied to other commercial products with 802.11a, GPS and GPRS applications. In FIG. 3, the radiator 28 is perpendicular to the ground plane 36 of the PCB 26, for bluetooth or 802.11b application, the length L1 of the radiator 28 is approximately 26 mm, and the width d3 is approximately 1-6 mm, which corresponds to a frequency of radio signals transmittable and receivable by the antenna 24. The distance d1 between the radiator 28 and the PCB 26 is 0.5-2.5 mm. The reason for keeping a distance between the radiator 28 and the PCB 26 is to avoid contact and the electric short that would result, and additionally to obtain a necessary bandwidth by adjusting the distance d1. The distance d2 between the feeding plate 30 and the ground plate 34 is 2.5-4.0 mm. The impedance match can be adjusted through adjusting the distance d2. The feeding plate 30 and the ground plate 34 both stretch out from the lower edge of the radiator 28, and are located on the same side and connected to the PCB 26. The feeding plate 30 and the ground plate 34 can also be connected to the lower or the upper edge of the radiator 28 separately. Please refer to FIG. 4. FIG. 4 is a schematic diagram of an antenna with a feeding plate 31 connected to the upper edge, and a ground plate 34 connected to the lower edge of the radiator 28. FIG. 4 shows one of the variations of setting the feeding plate 31 and the ground plate 34. The feeding plate 31 and the ground plate 34 can be installed on the same side or different sides, descriptions of the other variations are hereby omitted.

In this embodiment, since the radiator 28 of the antenna 24 is located off of the PCB 26, and the radiator 28 is perpendicular to the PCB 26, additional PCB 26 space is saved because the space next to the radiator 28 on the PCB 26 is free for other devices.

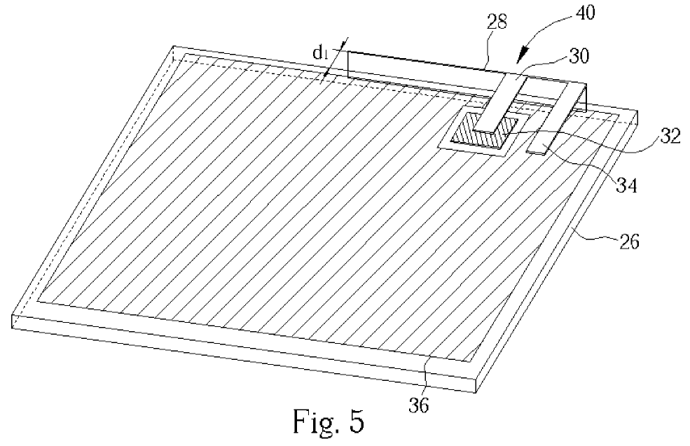

Please refer to FIG. 5. FIG. 5 is a diagram of a perpendicularly-oriented inverted F antenna 40 according to the second embodiment of the present invention. Because the components of the second embodiment are practically the same to those in the first embodiment, the numbering used in FIG. 3 is also used in FIG. 5. The antenna 40 is connected to a PCB 26, and includes a radiator 28 installed off the PCB 26 for receiving and transmitting RF signals, a feeding plate 30 stretching out from the radiator 28 and connected to a feed pad 32 of the PCB 26 for transmitting RF signals, and a ground plate 34 stretching out from the radiator 28 and connected to a ground plane 36 of the PCB 26.

The functions of the components in the second embodiment are the same to those in the first embodiment; therefore function descriptions are hereby omitted. The only difference between the two embodiments is that the feeding plate 30 and the ground plate 34 according to the second embodiment both stretch out from the upper edge of the radiator 28, instead of the lower edge as according to the first embodiment. Therefore the radiator 28 according to the second embodiment is located off the PCB 26 and positioned along the PCB 26 edge, instead of being located above the PCB 26 as according to the first embodiment. Again, a distance d1 is maintained between the radiator 28 and the PCB 26 in order to avoid contact and the resulting electrical short. Additionally, to obtain a necessary bandwidth, the distance d1 can be adjusted. The arrangement according to the second embodiment avoids the size increase due to the height of the radiator 28.

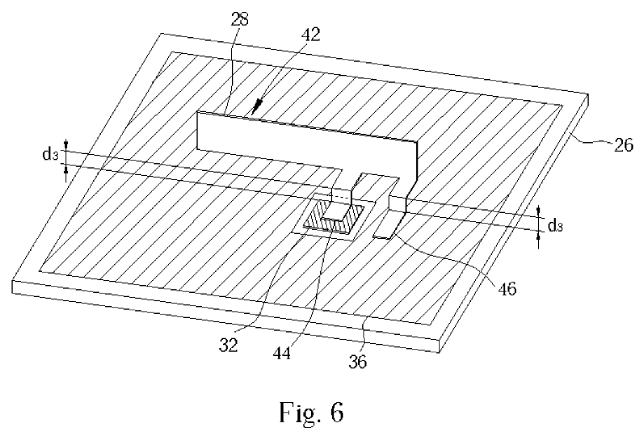

Please refer to FIG. 6. FIG. 6 is a schematic diagram of a perpendicularly-oriented inverted F antenna 42 according to the third embodiment of the present invention. The antenna 42 is connected to a PCB 26, and includes a radiator 28 installed above the PCB 26 for receiving and transmitting RF signals, a feeding plate 44 stretching out from the radiator 28 and connected to a feed pad 32 of the PCB 26 for transmitting RF signals, and a ground plate 46 stretching out from the radiator 28 and connected to a ground plane 36 of the PCB 26.

The functions of the devices in the third embodiment are the same as those in the first embodiment, therefore functional descriptions are hereby omitted. The difference between the two embodiments is that the antenna 42 is installed above the PCB 26, and the feeding plate 44 and the ground plate 46 both stretch out from the lower edge of the radiator 28 according to the third embodiment. However, the feeding plate 44 and the ground plate 46 can be bent over, and the height d3 is kept in order to avoid contact between the feeding plate 44 and the ground plane 36, thus resulting in electrical short. Additionally, to obtain the necessary bandwidth, the distance d3 can be adjusted. The arrangement according to the third embodiment can be used when there is no space available on the side of the PCB 26.

In contrast to the prior art, the radiator of the antenna is perpendicularly installed above or to the side of the circuit board according to the present invention. This arrangement is capable of saving space on the circuit board for other devices. Therefore, the present invention shows a more practical and better way to utilize the antenna in compact wireless mobile communication devices.

What is claimed is:

1. An antenna connected to a circuit board for wireless communication, the antenna comprising:
a radiator used to transmit and receive radio frequency (RF) signals, the radiator being perpendicular to a ground plane of the circuit board;
a feeding plate stretching out from the radiator and connected to a feed pad of the circuit board, used to transmit the RF signals; and
a ground plate stretching out from the radiator and connected to the ground plane.

2. The antenna of claim 1 wherein the radiator is installed to the side of the circuit board.

3. The antenna of claim 1 wherein the radiator is installed above the circuit board.

4. The antenna of claim 1 wherein the feeding plate and the ground plate are connected on the same side of the radiator.

5. The antenna of claim 1 wherein the feeding plate and the ground plate are connected on different sides of the radiator.

6. The antenna of claim 1 further comprising an expanding plate stretching out from a side of the radiator.

7. The antenna of claim 1 wherein the feeding plate stretches out from the upper edge of the radiator.

8. The antenna of claim 1 wherein the feeding plate stretches out from the lower edge of the radiator.

9. The antenna of claim 1 wherein the ground plate stretches out from the upper edge of the radiator.

10. The antenna of claim 1 wherein the ground plate stretches out from the lower edge of the radiator.

11. The antenna of claim 1 wherein the antenna is a single frequency antenna, and the length of the radiator is approximately quarter the wavelength of the RF signal transmitted by the antenna.

12. The antenna of claim 1 wherein the circuit board is a printed circuit board (PCB).
